(19) United States
(12) Patent Application Publication
(10) Pub. No.: US 2002/0089492 A1
(43) Pub. Date: Jul. 11, 2002

(54) Flat panel display with input device

(76) Inventors: Young-Soo Ahn, Seoul (KR); Young-Jin Oh, Namyangju-Si (KR)

Correspondence Address: LAW OFFICES OF BRIAN S STEINBERGER, 101 BREVARD AVENUE, COCOA, FL, 32922, US

(21) Appl. No.: 09/992,824

(22) Filed: Nov. 14, 2001

(30) Foreign Application Priority Data
Jan. 11, 2001 (KR) 2001-1608
Mar. 27, 2001 (KR) 2001-15850

(51) Int. Cl. G09G 5/00

(52) U.S. Cl. 345/173

(57) ABSTRACT

A flat panel display with input device having enhanced assemblability and lowered failure rate is achieved by connecting a touch screen driver with a display driver. Signal distortion is reduced by simplifying wiring. Reduction of signal distortion in an input device or a flat panel display and economic benefit in its manufacture occurs by constructing a display driver and a touch screen driver on the identical printed circuit board (PCB). A flat panel display with input device includes a display driver and a touch screen driver constructed by separate PCBs; an interface for connecting PCBs disposed on control boards; wiring on the touch screen configured to come into contact with the display driver board to be electrically connected to the board for the touch screen driver; and touch screen wiring provided on the control board for the display so the display driver board and the touch screen driver board can be electrically connected to each other through the interface, and wiring drawn from the touch screen contacts the display control board. The flat panel display with input device can include a display driver and touch screen driver constructed on the identical PCB; and separate controllers added to drivers on the display driver board and the touch screen driver board to drive the display and the touch screen. The touch screen controller includes at least one clock, an A/D converter, and an interface for mediating data for the touch screen.

This invention claims the benefit of priority to Korean Patent Application No. 2001-1608 filed Jan. 11, 2001 and Korean Patent Application No. 2001-15850 filed Mar. 27, 2001. The present invention relates to a flat panel display, and more particularly, a flat panel display with an input device wherein its assemblability is enhanced and its failure rate is lowered by connecting, through a circuit, a touch screen driving portion and a display driving portion, which are constructed by separate control boards, and wherein signal distortion from its wiring can be reduced by simplifying the wiring. In addition, the present invention relates to reduction of signal distortion in an input device or a flat panel display and to obtainment of economic benefit in view of its manufacture by constructing a display driving board and a touch screen driving board on the identical printed circuit board (PCB).

### BACKGROUND AND PRIOR ART

A touch screen has been known as an input device incorporated into or added to a computer, a portable transmitter, a spherical or aspherical displaying apparatus, a personal digital assistant (PDA), or the like. Although the touch screen (touch panel) is one input devices, it has features that its input operation is simple, there is little possibility of wrong operation, and it is possible to input characters with hands, as compared with the other input devices such as a mouse or a keyboard.

FIG. 1 is a sectional view showing the basic constitution of a resistive touch screen 10. An upper substrate 20 and a lower substrate 30 are structurally bonded by an adhesive 50 having thickness of 75 to 200 μm with transparent conductive films 40 thereof faced to each other. The upper substrate 20 comes into contact with the lower substrate 30 by pressure applied upon depression for input. The upper substrate 20 is made of a PET film or a thin glass sheet, which is flexible.

The detection of an input position is made by a structure configured such that the upper and lower substrates 20, 30 with electrodes put thereinto face each other with a gap of 100 to 300 μm by means of dot spacers 60, and that input signals are extracted by a connector tail. As for its operation, the upper substrate 20 comes into contact with the lower substrate 30 on an input point and a voltage is applied between the electrodes of the lower substrate 30 so that a potential gradient is produced on resistive surfaces between both electrodes. The resulting voltage is read through the electrodes of the upper substrate 20 and an X-axis input position is then calculated by a controller. Subsequently, a voltage is applied between the electrodes of the upper substrate 20 and the resulting voltage is read through the electrodes of the lower substrate 30 so as to calculate a Y-axis input position. Thus, the input point is shown on the display. By repeating the above procedures at a high rate, input positions are continuously shown on the display so that characters or lines are drawn.

In order to meet required characteristics of the touch screen requested by a user, the structure of the touch screen may be partially modified to accept a certain extent of the required characteristics. However, it is difficult to accept all of the required characteristics. In addition, there is a limit on acceptance of the required characteristics by means of only the resistive touch screen. Therefore, there is a need to select an optimal one of the structures or detecting methods of the touch screen suitable for the various required characteristics.

In view of the required characteristics, the resistive touch screen is suitable for daily life of the general public where the price, productivity, character writing and the like thereof have priority over all other things. An elastic wave type touch screen is suitable for use in industrial equipments where the durability, optical properties, insulating property, and the like thereof have priority over other things. Therefore, the characteristics of the touch screen depend entirely on selection of the touch screen by the user.

There are many cases where an LCD is used for a display. There are many types of LCDs, and thus, they are properly utilized according to usage of products. In order to classify the LCDs, various classifying manners are taken into consideration. For example, it is possible to classify the LCDs into monochrome and color types, frontlight and backlight types, or STN and TFT types in view of their structures. In particular, due to the improvements of high resolution of the TFT and color yield of the frontlight type LCD, there is a great demand for the touch screen to be mounted on the LCD.

Generally, the length from an outermost periphery of a visual area of the touch screen to an outer periphery of the touch screen is called an inactive area. The inactive area is an obstacle to the miniaturization, thinness, and improvement in an effective area ratio of a screen of the product. The inactive area of the LCD has been largely reduced, so that the inactive area of the touch screen should be necessarily reduced due to a limitation on an assembly structure of them, in which the dimension of the touch screen should be smaller than that of the LCD. However, the simple reduction of the inactive area of the touch screen produces problems that linearity and insulation shield of the electrodes are lowered and it is likely that noise is produced due to easy intrusion of an electromagnetic wave and static electricity. Complementary technologies for the above problems have been continuously proposed.

The touch screen still has a problem of whether it can exhibit an expected performance in combination with a display such as a LCD and meet various demands (required characteristics), as explained above.

FIG. 2 schematically shows a sectional structure made by a technology of stacking the resistive touch screen on the flat panel display according to the required characteristics.

The structure of FIG. 2 is a flat panel display with a touch screen added thereto, configured in such a manner that a polarizer 70 is put on the bottom of a touch screen 10 comprised of an upper substrate 20 and a lower substrate 30, a liquid crystal display device 80 is put on the bottom of the polarizer 70, another polarizer 70 is put on the bottom of the liquid crystal display device 80 again, and they are finally stacked together.

Here, the polarizers 70 serve to convert visible rays into linearly polarized light on both sides of the liquid crystal display device 80 of the flat panel display 11. The technology of stacking the touch screen 10 on the flat panel display 11 by using the polarizers 70 aims at enhancing light transmissivity while maintaining all optical axes and simultaneously at thinness and lightness thereof in view of its stacking structure. Various methods by which the maintenance of the optical axes can be achieved by measures such as use of optically isotropic materials and the light transmissivity can also be improved in view of the sectional structure by using optimal materials are advantageous to the thinness, miniaturization, and lightness thereof. The application of the stacking structure is taken into consideration at least within the range favorable to the thinness, miniaturization, and lightness thereof.

The technology of adding or incorporating the touch screen 10 to or into the display 11 has required optimization of design of a drive circuit or board for driving the touch screen 10 and the display 11, in addition to the stacking structure in which the required characteristics are taken into consideration as mentioned above.

In a typical structure, respective control boards drive the display 11 and the touch screen 10, the respective electrodes of the touch screen 10 are gathered on one side in consideration for convenience of connection of the wiring for signal transmission, and the wiring extends longitudinally and is connected to a control board for the touch screen. This structure can be considered as a case where a driving portion is placed at an optimal position for processability, performance, and design for miniaturization and thinness of the product under the limited conditions.

However, according to this structure, the weak connecting wiring may be easily broken during the process of assembling the added touch screen with the display, or may lengthily extend to the outside so that its external appearance is deteriorated. Further, due to signals transmitted through the long wiring, it is likely that signal distortion is produced by the control board for the display. Such structure of the driving portion has a problem in that it does not meet the processability, the performance, and the design for the miniaturization and thinness of the product. The problem related to the wiring of the display and the touch screen will be better understood with reference to sectional structures schematically shown in FIGS. 3 and 4.

FIG. 3 is a schematic sectional view of a case where the touch screen 10 is mounted on the liquid crystal display device 80. Here, the liquid crystal display device 80 has sealants 83 provided on both ends of a substrate 81 with thin film transistors formed thereon. The sealants 83 are a kind of adhesive for bonding a substrate 82 disposed above the sealants and the substrate 81 disposed below the sealants and are also sealing materials for holding liquid crystals between the substrates 81, 82. Further, a first anisotropic conductive film 84a is placed on one side of the substrate 81, and a second anisotropic conductive film 84b is formed on a printed circuit board 85 spaced apart from the substrate 81. A flexible printed cable (FPC) 86 is bonded on the first and second anisotropic films 84a, 84b; and a driving IC 87 is placed on the FPC 86. Moreover, the polarizer 70 is installed on the substrate 82 and converts incident light from the outside into linearly polarized light. The lower substrate 30 of the touch screen 10 is stacked on the polarizer 70 on which, in turn, the upper substrate 20 with a hard coating material coated thereon is stacked. The lower and upper substrates 30, 20 correspond to the touch screen 10.

The lower substrate 30 of the touch screen 10 has a layer of transparent electrode formed thereon and the electrodes are formed on the layer of transparent electrode. Similarly, the upper substrate 20 also has a layer of transparent electrode and a layer of low resistant metal electrode formed thereon, which are disposed on the X- and Y-axes. The layers of the upper substrate 20 output electrical signals in response to pressure applied from the outside (upper substrate).

FIG. 4 schematically shows a front face (top plane) of the lower substrate 30. A plurality of X-axis and Y-axis electrodes 32a, 32b are formed at predetermined intervals on a surface along a periphery of a rectangular active area 31 that is a position detecting area of the touch screen 10. Further, in an inactive area 33 surrounding the active area 31, there is a wiring 34 connected with the X-axis and Y-axis electrodes 32a, 32b. The wiring 34 connects the driving portion of an external circuit device to the X-axis and Y-axis electrodes 32a, 32b via a portion of a periphery of the inactive area 33 and a portion of the inactive area 33 itself. Here, the active area 31 is an area in which the touch screen 10 actually detects positions, and is defined by the X-axis and Y-axis electrodes 32a, 32b made of flat straight type low resistant metal or grid-type sheet metal.

In such case where there are the electrodes of the substrates constituting the touch screen 10, and the wiring 34 for transmitting signals between the electrodes and the driving portion, according to a conventional wiring method, the wiring 34 is gathered in one direction in consideration of connection workability upon connection of the driving portion. The wiring 34 extends lengthily and is connected to a control board 35 for the touch screen.

Since the touch screen (digitizer) is generally matched to the display (LCD) one to one, the touch screen 10 is placed directly on a front face of the display 11, as shown in FIGS. 2 and 3. In most cases, the display 11 is a flat panel display. However, it may be a display having a curved surface such as a cathode-ray tube (CRT). Here, an ordinary display has the driving portion at the rear of the display, and may have it at the bottom of the display, if necessary. If the display is the flat type, it may be the LCD. If the display is the curve type, it may be the CRT or the like. In either case, the driving portion should be placed at an optimal position for displaying. In such case, since the control board 35 for driving the touch screen is made separately from a control board for driving the display, the touch screen comes into contact with the display as shown in FIG. 3 and the wiring is then drawn out to be connected to the touch screen 10. That is, since the direct connection to the complete and separate driving control boards should be made, the structure is difficult to perform the connection work and it is also difficult to prevent the signal distortion due to the length of the wiring in view of characteristics of the product. Furthermore, the structure is not suitable for the design for accepting the required characteristics such as miniaturization and thinness.

FIG. 5 shows the conventional touch screen 10. It can be seen that a connector 36 to be connected to the driving circuit portion (control board for the touch screen) is attached to the right side of the touch screen 10.

FIG. 6 shows a circuit portion for driving the touch screen of FIG. 5, and respective connecting portions.

A connector 37 connects a driving circuit portion 38 to a system, i.e. a central processing unit of a PC, a kiosk, or the like. Another connector 39 is a connecting portion for supplying power required for operation of a board of the driving circuit portion 38. The connector 39 may be eliminated if the necessary power is supplied through other connecting portions. The driving circuit portion 38 serves to perform switching for operating the touch screen 10 and to transfer data to the system. Finally, a connector 41 is a portion to be connected to the connector 36 of the touch screen 10 of FIG. 5. However, there may be a case where the wiring is connected by other methods such as welding without an additional connecting component such as the connector 41.

Therefore, it can be said that the constitutions of FIGS. 5 and 6, and driver programs required for driving them are included in the touch screen 10. Assuming that the touch screen 10 is mounted on a front face of a notebook computer 42 as shown in FIG. 7a, on a front face of a desktop computer 43 as shown in FIG. 7b, or on a kiosk (not shown), the wiring is made as shown in FIG. 8.

Referring to FIG. 8, the system connecting portion and the connecting portion of the touch screen 10 and the driving circuit portion 38 extend to the outside of the notebook computer 42.

Therefore, in consideration of the external appearance and function thereof, there is no other way but to design the driving circuit portion 38, the system connecting portion and the like to be placed in the interior of the notebook computer 42. At this time, since the touch screen 10 is designed to be in closest contact with the display, it has a sectional structure similar to that of FIG. 9.

FIG. 9 shows the LCD by way of example, wherein the touch screen 10 is placed on the display 11, a light source 12 is put beneath the display 11 (such light source is not required for a self-luminous device such as a frontlight type LCD or an organic EL), and a driving portion 44 for the display, which is a driving circuit for the display, is placed at the lowest position.

FIGS. 10a and 10b are block diagrams of the display driving portion 44 and the touch screen driving portion 45, respectively. The display driving portion 44 includes a power supplying portion 52 for generating power by using a fundamental power supplied from the system 51 and supplying the generated power to respective portions; a controller 55 for receiving respective timing information and information on R, G and B colors required for the display 11 from the system 51, converting the information into signals suitable for a gate driver 53 and a data driver 54, and transmitting the signals to the gate and data drivers 53, 54; and a color processing portion 56 serving as a kind of color table for constructing correct colors, as shown in FIG. 10a. In the touch screen driving portion 45, a power supplying portion 52 supplies power to respective portions by using the fundamental power supplied from the system 51. As for the operation of the touch screen 10, a controller 59 that receives a clock 57 of the power supplying portion 52 performs switching driving of the touch screen 10. When touch is made, a voltage value generated at this time is transmitted to an A/D converter 58 that, in turn, converts the voltage value into a digital value to be transmitted to the controller 59. At this time, the controller 59 controls the A/D converter 58 in an appropriate timing. Thereafter, the controller 59 that has received the data transmits a value of X/Y coordinates to the system 51 through an interface portion 61, and receives a proper value from the system 51 again so as to perform the next operation.

Therefore, in the structure of the display with the touch screen added thereto, the circuit portion for the touch screen should exist in the display. The position of the circuit portion would be identical with that of the display driving portion in section. In this case, when the touch screen and the touch screen driving portion are electrically connected directly to each other to be operated, additional signal lines are connected while crossing each other and lengthily extend over the display driving portion so that it is inconvenient to handle the signal lines. In addition, since the signal lines are dangled lengthily, there is a great possibility that signal distortion due to an induction effect with respect to the lower circuit driving portion can be produced.

In such driving portion for the conventional display with the touch screen added thereto, there is a problem in that the wiring is lengthened and thus the failure in assembly thereof may be largely produced. Further, there is another problem in that the wiring for connection to the board for the touch screen is complicated and thus it cannot make provisions against the signal distortion. Moreover, there is a further problem in that it is difficult to efficiently arrange spaces upon design of the product and thus it is disadvantageous to the compactness of the products. Furthermore, there is a still further problem in that input into the system such as through a PC cannot be done in the control board for the display and thus it is disadvantageous to the interface.

### SUMMARY OF THE INVENTION

Therefore, an object of the present invention is to provide a flat panel display with a touch screen added thereto, wherein a touch screen driving portion and a display driving portion, which are constructed by control boards, are connected through a circuit to improve assemblability thereof.

Another object of the present invention is to provide a flat panel display with a touch screen added thereto, wherein the circuit wiring of a driving portion can be shortened.

A further object of the present invention is to provide a flat panel display with a touch screen added thereto, wherein a failure in the wiring for connecting a touch screen driving portion and a display driving portion can be reduced.

A still further object of the present invention is to provide a flat panel display with a touch screen added thereto, wherein the wiring for connecting a touch screen driving portion and a display driving portion can be simplified.

A still further object of the present invention is to provide a flat panel display with a touch screen added thereto, wherein compactness of a space for a driving portion can be realized.

A still further object of the present invention is to provide a flat panel display with a touch screen added thereto, wherein input into a system can be done in a control board for a display.

In order to achieve the above objects, according to one aspect of the present invention, there is provided a flat panel display with an input device added thereto, in which a touch screen is mounted on a display and control boards and driving circuit boards are connected to the touch screen and the display so as to serve to perform switching for operating the touch screen and to send data to a display system. The flat panel display comprises a display driving portion and a touch screen driving portion constructed by respective separate (printed circuit boards)PCBs; an interface medium for electrically connecting PCBs disposed on control boards of the respective driving portions; wiring on the touch screen configured such that it is drawn out from the board for the touch screen driving portion and comes into contact with the board for the display driving portion to be electrically connected to the board for the touch screen driving portion; and touch screen driving wiring provided on the control board for the display so that the boards for the display driving portion and the touch screen driving portion constructed by the separate PCBs can be electrically connected to each other through the interface medium, and at the same time, the wiring drawn out from the touch screen can first come into contact with the control board for the display.

According to another aspect of the present invention, there is provided a flat panel display with an input device added thereto, in which a touch screen is mounted on a display, and driving circuit boards are connected to the display and the touch screen so as to serve to perform switching for operating the touch screen and to send data to a display system. The flat panel display includes driving portions having controllers for driving the display and the touch screen. The flat panel display also comprises a display driving portion and a touch screen driving portion constructed on the identical PCB; and separate controllers added to driving portions on driving boards of the display driving portion and the touch screen driving portion in order to drive the display and the touch screen. The controller for the touch screen includes at least one clock generator for providing a clock by being interlocked with a substrate of the touch screen, an A/D converter, and an interface portion for mediating data for the touch screen with respect to the system.

In this way, the touch screen driving portion and the display driving portion, which are constructed by the control boards, are connected through a circuit upon electrical connection of the display and the input device. Thus, since the wiring drawn out from the touch screen is shortened and connected to the control board for the display, and then, the control board for the touch screen can be connected to the control board for the display, the problems such as signal distortion can be greatly solved.

Further objects and advantages of this invention will be apparent from the following detailed description of the presently preferred embodiments which are illustrated schematically in the accompanying drawings.

### BRIEF DESCRIPTION OF THE DRAWINGS

FIG. 1 is a view showing a sectional structure of a conventional touch screen.

FIG. 2 is a view showing a stacking structure of a conventional touch screen and flat panel display.

FIG. 3 is a schematic view showing a stacking structure of a liquid crystal display device as a typical flat panel display and a digitizer or touch screen as an input device by way of example.

FIG. 4 is a front view of the digitizer or touch screen of FIG. 3.

FIG. 5 is a view showing a touch screen and its connector.

FIG. 6 is a constitutional view of conventional connecting elements for connecting the display and the touch screen.

FIGS. 7a and 7b show examples of a display on which a touch screen can be mounted, wherein FIG. 7a shows a notebook computer and FIG. 7b shows a personal computer.

FIG. 8 is a view illustrating one example of the connecting wiring of a conventional display and touch screen.

FIG. 9 is an exemplifying view illustrating a sectional structure of a liquid crystal display device and a touch screen, which is centered around a conventional connecting wiring.

FIGS. 10a and 10b are block diagrams of driving PCBs of a conventional flat panel display with an input device added thereto, wherein FIG. 10a shows a display driving portion and FIG. 10b shows a touch screen driving portion.

FIG. 11 is a view showing the connecting wiring of a flat panel display and a touch screen according to the present invention.

FIG. 12 is a schematic view of a rear face of FIG. 11.

FIG. 13 is a schematic view of a rear face of another example of the connecting wiring according to the present invention.

FIG. 14 is a block diagram of the entire blocks of a driving PCB block embodied according to the application of the present invention.

FIG. 15 is a block diagram of another driving PCB block and the entire blocks therein embodied according to the present invention.

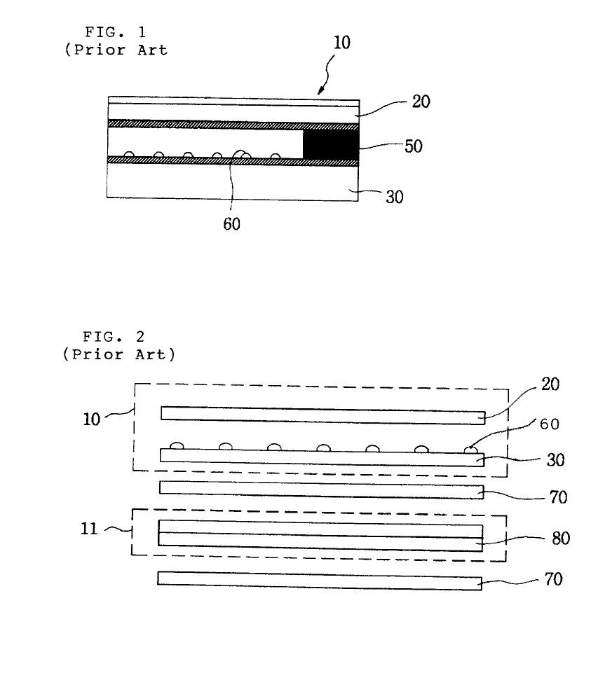

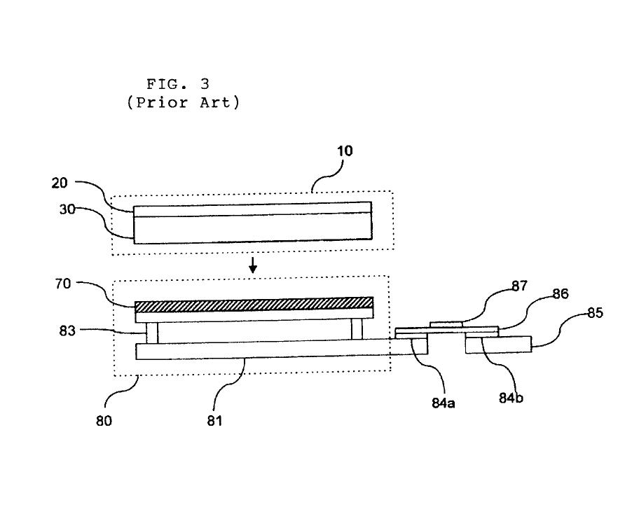

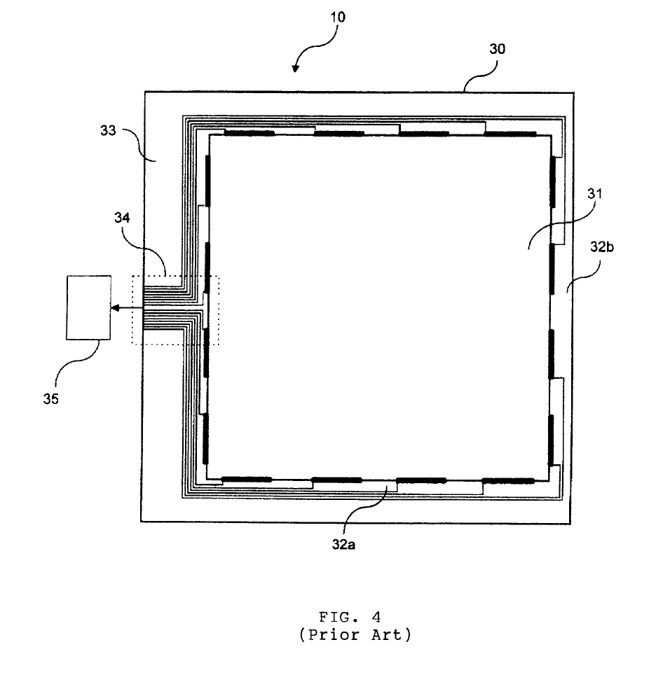

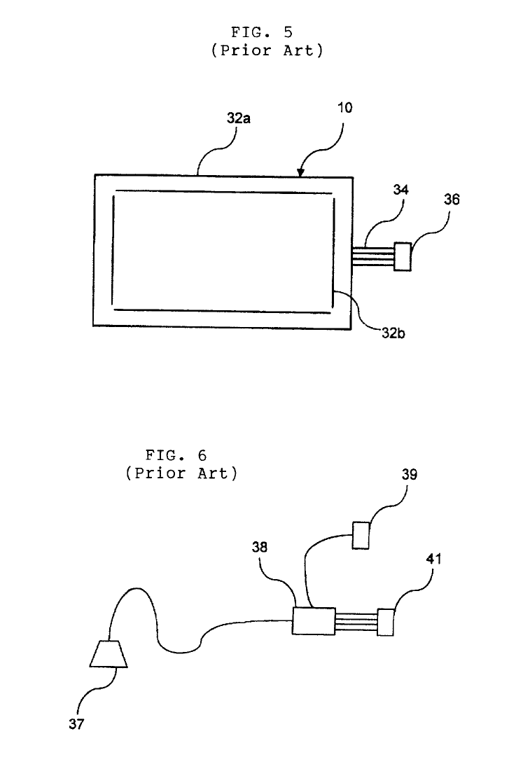

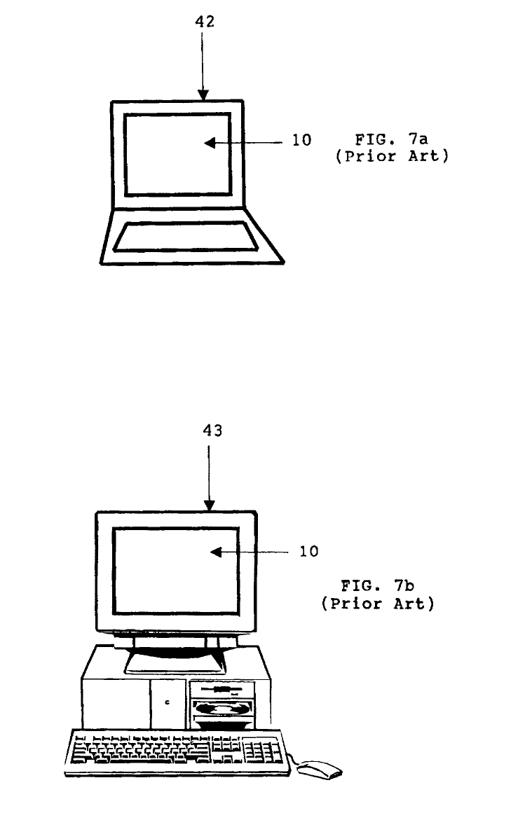

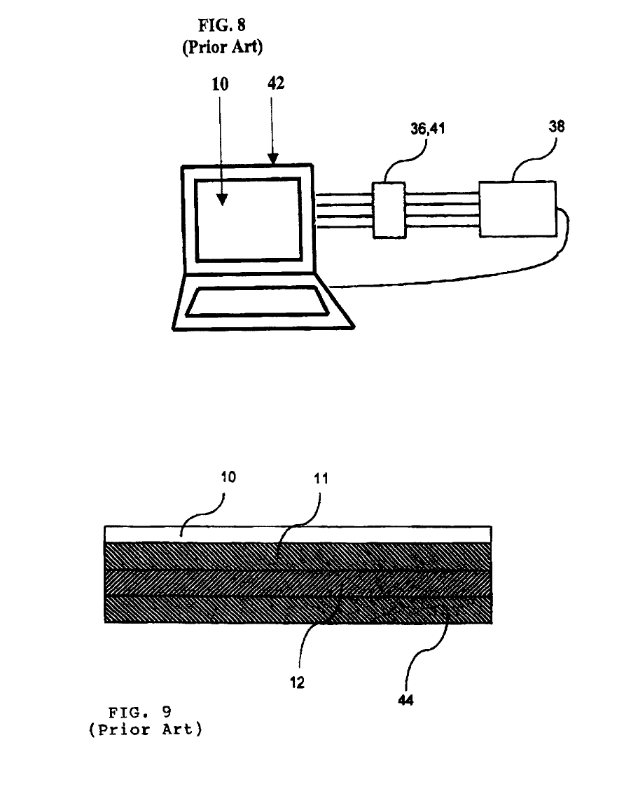

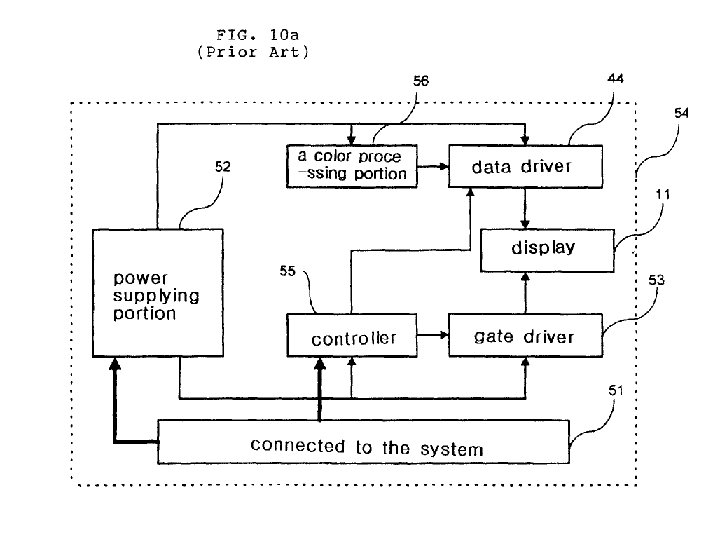

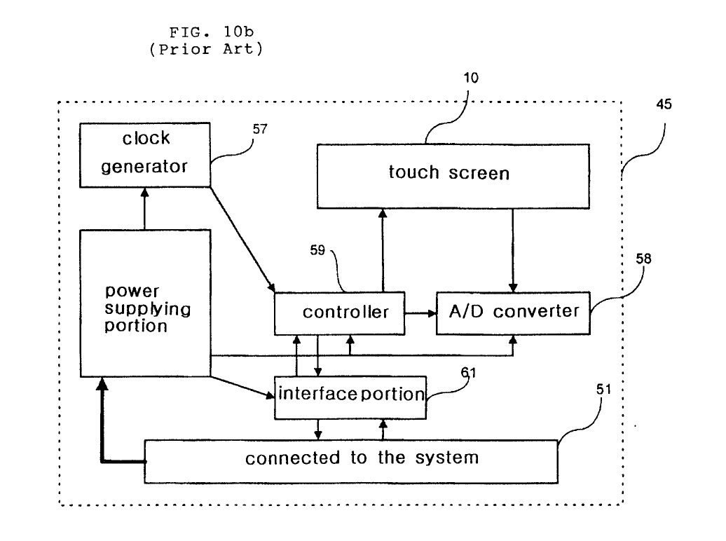

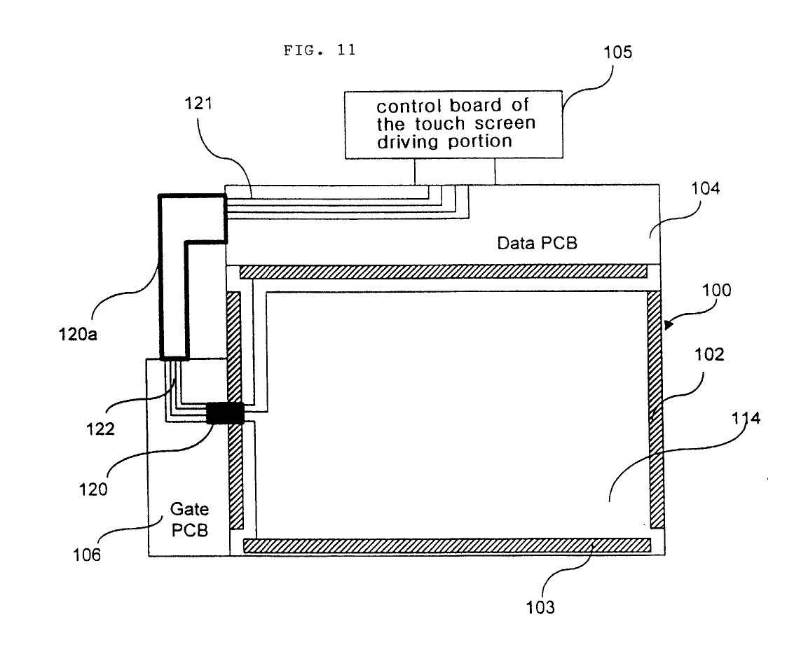

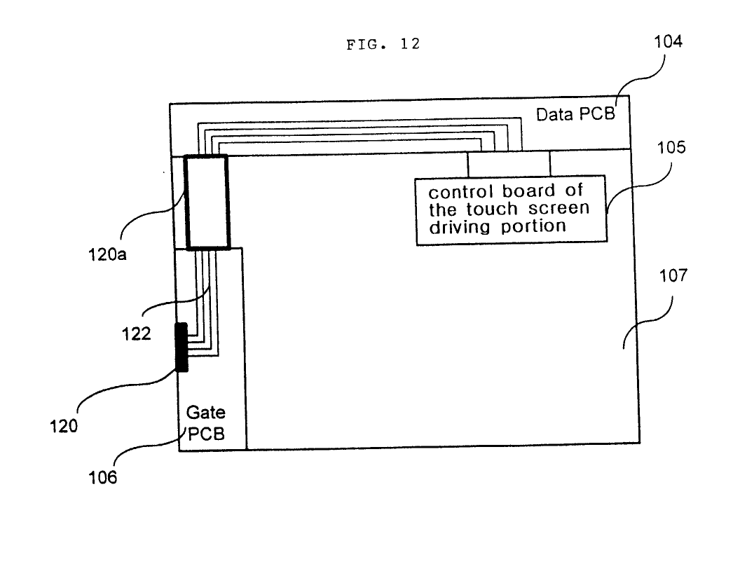

### DETAILED DESCRIPTION OF THE INVENTION

Before explaining the disclosed embodiments of the present invention in detail it is to be understood that the invention is not limited in its application to the details of the particular arrangements shown since the invention is capable of other embodiments. Also, the terminology used herein is for the purpose of description and not of limitation.

Referring to FIGS. 11 to 13, according to the present invention, a gate PCB 106 and a touch screen driving portion 105 are separated from each other as separate PCBs. The respective PCBs for the gate PCB 106 and the touch screen driving portion 105 are constructed by means of electrical connections through media of interfaces 120, 120a. The wiring drawn out from a touch screen 114 is not connected directly to a board of the touch screen driving portion 105, but electrically connected to the board of the touch screen driving portion 105 after it is first connected to the gate PCB 106. The gate PCB 106 is provided with wiring 122 for driving the touch screen so that the gate PCB 106 and the control board of the touch screen driving portion 105, which are separated from each other as the separate PCBs can be electrically connected through the media of interfaces 120, 120a, and wiring 121 drawn out from the control board of the touch screen driving portion 105 can be first connected to the gate PCB 106.

FIG. 11 is a front view showing a coupled state of a touch screen and an LCD. In order to apply signals to an electrode 102 of the touch screen 114, a data PCB 104 is connected to the gate PCB 106 so that the signals are transmitted through the connection, as shown in the figure. At this time, the connecting portion (interface) can be preferably constructed by a FPC like this embodiment or by a wire.

Although FIG. 11 shows that the present invention is applied to the LCD by way of example, it can also be similarly applied to an EL or any other displays. In particular, in the case of the LCD, the board of the touch screen driving portion can be connected to either the data PCB or the gate PCB.

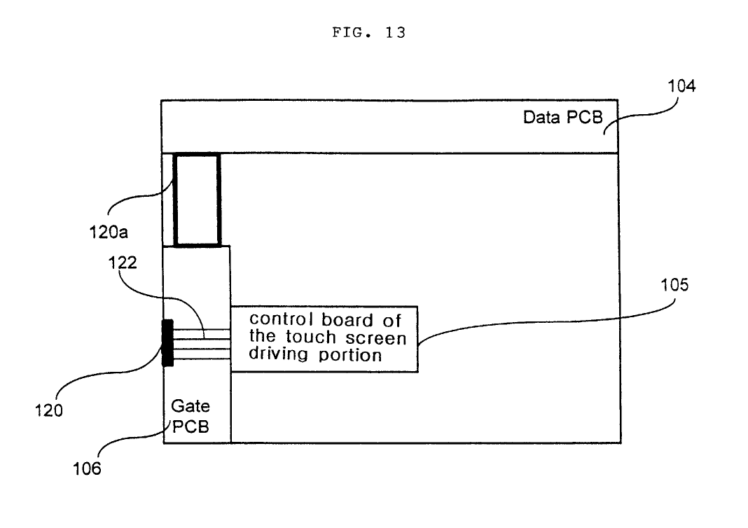

FIG. 12 shows schematically a rear face of FIG. 11. In this figure, the board of the touch screen driving portion 105 is electrically connected to the gate PCB 106.

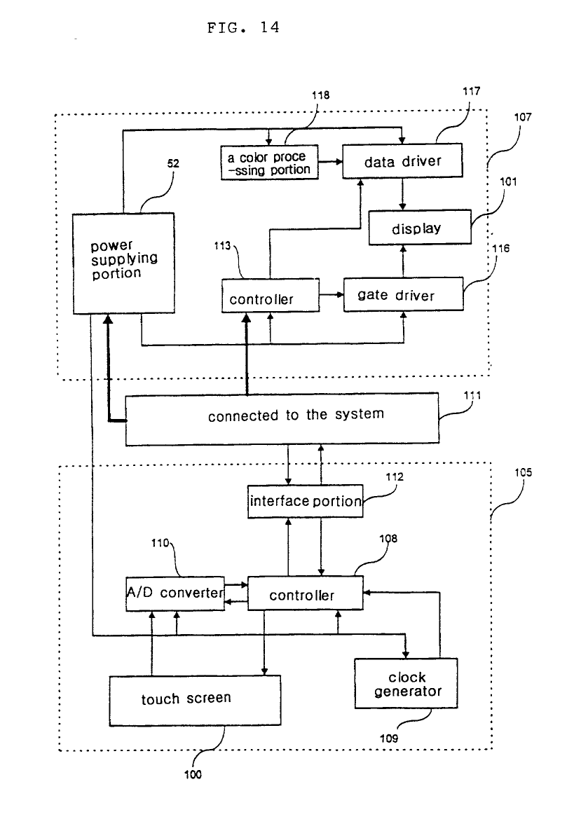

FIG. 13 shows schematically another embodiment of FIG. 12. In this figure, it can be seen that the board of the touch screen driving portion 105 is electrically connected to the gate PCB 106. Contrary to FIG. 12, it is a case where the touch screen driving portion is connected to the gate PCB of the LCD. Here, the connection is made by means of print wires on the PCB.

Such input device of the touch screen is characterized in that a separate control board is interfaced by means of electrical connection. Particularly, the control board for the display contains an interface part for driving the touch screen therein and also has a wiring portion for transmitting and receiving signals to and from the electrode of the touch screen. Therefore, the touch screen can be connected to the display without an additional circuit portion for the touch screen. Further, as shown in FIGS. 11 to 13, there is no intersection of signal lines due to direct connection of the touch screen and the circuit portion for driving the touch screen.

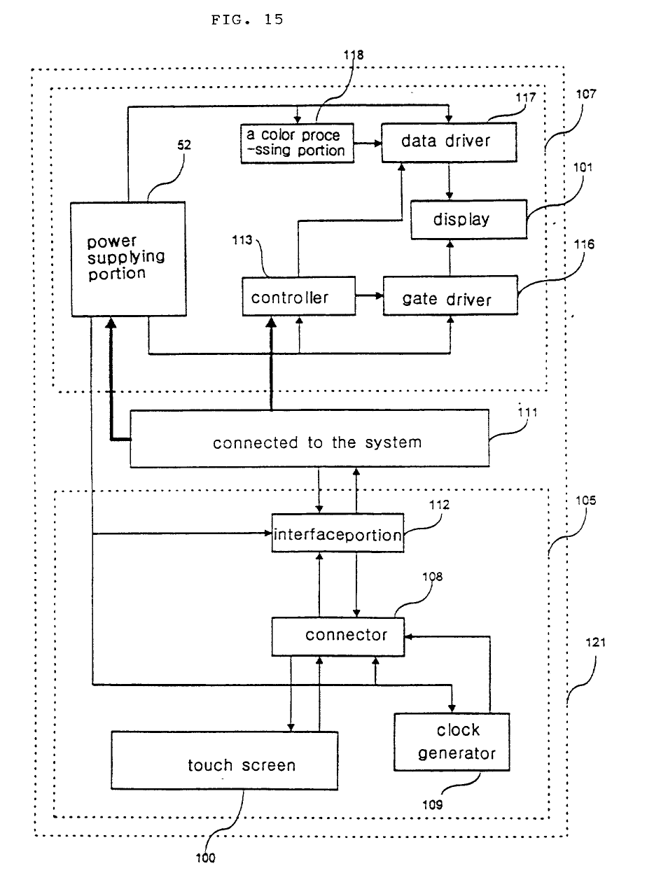

Moreover, in a flat panel display with an input device added thereto according to the present invention as shown in FIGS. 14 and 15, a touch screen is mounted on a display, and driving circuit boards are connected to the display and the touch screen so as to serve to perform switching for operating the touch screen and to send data to a display system. The flat panel display with the input device added thereto includes driving portions having controllers for driving the display and the touch screen. A display driving portion 107 and the touch screen driving portion 105 exist on one PCB, and an additional controller 108 for driving the display and the touch screen is configured such that it is added to the display driving portion 107 and the touch screen driving portion 105 above the PCB for driving the display. The controller 108 is constructed by connecting at least one clock generator 109 for providing a clock, an A/D converter 110, and an interface portion 112 for mediating data for the touch screen with respect to a system 111.

FIG. 11 is a front (top plan) view of a coupled state of the touch screen 100 and the LCD 101. In order to apply signals to X-axis and Y-axis electrodes 102, 103 of the touch screen 100, the control board of the touch screen driving portion 105 exists on the data PCB 104 so as to transmit the signals through the control board of the touch screen driving portion 105 placed on the data PCB 104. Therefore, since the control board of the touch screen driving portion exists on the data PCB 104, it is not connected through a FPC (flexible printed cable) or a wire but coexists on the PCB using identical power and a ground plane.

Further, the touch screen driving portion 105 can exist on any one of the data PCB 104 and the gate PCB 106. For example, it can be placed selectively on either the data PCB 104 or the gate PCB 106.

FIG. 12 shows a rear face of a coupled structure of the touch screen and the display, in which the control board of the touch screen driving portion 105 can be connected directly to the board of the display driving portion.

FIG. 13 shows a rear face of another coupled structure of the touch screen and the display, in which the control board of the touch screen driving portion 105 is connected directly to the gate PCB 106 and then connected directly to the board of the display driving portion 107. Contrary to FIG. 11, FIG. 13 shows the case where the control board of the touch screen driving portion 105 is attached to the gate PCB 106 of the display.

FIG. 14 shows the entire blocks of a driving PCB block that can be embodied by the constitutions shown in FIGS. 11 to 13. There is the controller 108 for driving the touch screen 100, which is an essential part of the present invention. There are also the clock generator 109 and the A/D converter 110 for controlling the system 111. The controller 108 is connected to the system 111 and the interface portion 112.

FIG. 15 shows another driving PCB block 121 and the entire blocks therein, which can be realized by the constitutions shown in FIGS. 11 to 13. There is the controller 108 for driving the touch screen 100. The controller 108 is provided with the clock generator 109. Here, the A/D converter 110 shown in the embodiment of FIG. 14 is housed in the controller 108 for driving the touch screen.

In such way, according to the present invention, the display driving portion 107 and the touch screen driving portion 105 exist on the identical data PCB 104 or gate PCB 106. The touch screen driving portion 105 can be placed on any one of the gate PCB 106 and the data PCB 104 of the display driving portion 107. If the PCB for driving the display 101 is a single PCB that cannot be divided into two PCBs, the touch screen driving portion 105 also exists on the same PCB.

The PCB has the additional controller 108 for driving the touch screen besides a controller 113 for driving the display. In order to drive the controller 108 for driving the touch screen, at least one clock generator 109 is additionally mounted on the PCB for driving the display.

The controller 108 for driving the touch screen communicates data for the touch screen rather than data for the display to the system 111 through the interface portion 112. That is, contact or connection terminals for transmitting the data for the touch screen exist on the PCB for the display driving portion, in addition to signal lines for transmitting the data for the display. The data for the touch screen are values of X/Y coordinates of portions of the touch screen which a user presses down. The upper substrate 114 of the touch screen 100 is connected to an input terminal of the controller 108. An output terminal of the controller 108 is connected to an input terminal of the A/D converter 110. An output terminal of the A/D converter 110 is connected to the controller 108. The clock generator 109 is connected to the controller 108 to transmit clock signals and predetermined levels of voltage to the controller 108.

As for its operation, the controller 108 applies a voltage to a substrate with the Xaxis and Y-axis electrodes 102, 103 arranged thereon and waits for input of a user. When the user brings his/her hands or a pen into contact with the substrate, the substrate senses a change in values of resistance, capacitance, or potential therein and transmits it to the controller 108 in the form of a voltage value.

The controller 108 that has received the voltage value reads out a value of X/Y coordinates by means of a program stored in an internal memory based on the received voltage value and transmits the value of X/Y coordinates to the A/D converter 110. The A/D converter 110 performs data conversion of the received analogue value of X/Y coordinates into a digital value and outputs the converted digital value. The interface portion 112 converts the digital value of X/Y coordinates into a form suitable for transmission to an outer device and then outputs it.

FIG. 14 shows the entire blocks of the driving PCB block according to the present invention, in which the display driving portion 107 and the touch screen driving portion 105 are incorporated into the system 111.

The display driving portion 107 operates only when power is supplied thereto. A power supplying portion 115 generates the power by using the fundamental power supplied from the system 111. In addition, the controller 113 receives respective timing information and information on R, G and B colors required for the display 101 from the system 111, converts the information into signals suitable for the gate driver 116 and the data driver 117, and transmits the signals to them. A color processing portion 118 serves as a kind of color table for constructing correct colors.

Each part of the touch screen driving portion 105 is supplied with power by using the fundamental power supplied from the system 111. As for the important driving of the touch screen 100, the controller 108 that has received the clock from the clock generator 109 performs the switching driving of the touch screen 100. When a touch is made, a voltage value generated at this time is transmitted to the A/D converter 110 (including a case where the A/D converter is housed in the controller) that, in turn, converts the voltage value into a digital value to be transmitted to the controller 108. At this time, the controller 108 controls the A/D converter 110 in an appropriate timing. Thereafter, the controller 108 that has received the data transmits a value of X/Y coordinates from the X-axis and Y-axis electrodes 102, 103 to the system 111 through the interface portion 112, and receives a proper value from the system 111 again so as to perform the next operation.

The display with the input device added thereto according to the present invention constructed as such is characterized in that the separate control boards are interfaced by electrically connecting them to each other. Particularly, the control board for the display houses the interface parts for driving the touch screen therein, and also has the wiring portion for applying and receiving signals to and from the electrodes of the touch screen.

Therefore, the touch screen can be connected to the display without an additional circuit portion for the touch screen. Further, there is no intersection of signal lines due to direct connection of the touch screen and the circuit portion for driving the touch screen.

As described above, most of the displays and touch screens used as input devices are driven by separate control boards, respectively. Especially, in a process of adding and assembling the touch screen to the conventional display, the weak connecting wiring is easily broken or is lengthily drawn out to the outside, which is not desirable. Further, in the signals transmitted through the long wiring, it is likely that the signal distortion is produced by the control board for the display. However, when the input device for the display is constructed according to the present invention, the short wiring drawn out from the touch screen is connected to the control board for the display and the control board for the touch screen is simply connected to the control board for the display. Thus, the problems of the long signal lines and various arrangement of the wiring can be solved.

Therefore, since the length of the wiring is shortened, assembly thereof during an assembling process can be easily made and an influence due to interference of the wiring is reduced. Further, the wiring for connecting with the control board for the touch screen is simplified and thus the signal distortion due to the wiring can be decreased. Moreover, upon design of the display having the input device, the wiring is properly arranged and thus the degree of freedom of a space design is increased. Furthermore, since input of data into the system can also be made in the control board for the display, it is more advantageous over a conventional wiring manner in view of its interface.

In such a way, according to the present invention, since the circuit wiring of the driving portion is shortened, the assembly yield can be increased and the failure rate can be lowered.

In addition, since the connecting wiring between the driving portions of the touch screen and the display can be simplified, the signal distortion due to the signal wiring can be reduced.

Further, upon design of the product of the flat panel display with the touch screen added thereto, efficient space arrangements can be made and thus an optimal design such as compactness of the products can be achieved.

Moreover, since the input into the system in the flat panel display with the touch screen added thereto can be made in the control board for the display, there is an advantage in that it can be applied to the design of a system in which an input position is varied.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A flat panel display with an input device added thereto, in which a touch screen is mounted on a display and control boards and driving circuit boards are connected to said touch screen and said display so as to serve to perform switching for operating said touch screen and to send data to a display system, comprising:
a display driving portion and a touch screen driving portion constructed by respective separate PCBs(printed circuit boards);
an interface medium for electrically connecting PCBs disposed on control boards of said respective driving portions;
wiring on said touch screen configured such that it is drawn out from said board for said touch screen driving portion and comes into contact with said board for said display driving portion to be electrically connected to said board for said touch screen driving portion; and
touch screen driving wiring provided on said control board for said display so that said boards for said display driving portion and said touch screen driving portion constructed by said separate PCBs are electrically connected to each other through said interface medium, and simultaneously, said wiring drawn out from said touch screen comes into contact with said control board for said display.

2. A flat panel display with an input device added thereto, in which a touch screen is mounted on a display, and driving circuit boards are connected to said display and said touch screen so as to serve to perform switching for operating said touch screen and to send data to a display system, said flat panel display including driving portions having controllers for driving said display and said touch screen, comprising:
a display driving portion and a touch screen driving portion constructed on an identical PCB(printed circuit board); and
separate controllers added to driving portions on driving boards of said display driving portion and said touch screen driving portion in order to drive said display and said touch screen, said separate controller for said touch screen including at least one clock generator for providing a clock by being interlocked with a substrate of said touch screen, an A/D(analog to digital) converter, and an interface portion for mediating data for said touch screen with respect to said display system.

3. The flat panel display with the input device added thereto as claimed in claim 2, wherein said touch screen driving portion exists on a data PCB.

4. The flat panel display with the input device added thereto as claimed in claim 2, wherein said touch screen driving portion is on one of: a data PCB and a gate PCB.

5. The flat panel display with the input device added thereto as claimed in claim 2, wherein said board of said touch screen driving portion is coupled directly to said board of said display driving portion.

6. The flat panel display with the input device added thereto as claimed in claim 2, wherein said controller for said touch screen has a built-in A ID(analog to digital) converter.
